(19) United States
(12) Patent Application Publication
(10) Pub. No.: US 2010/0233970 A1
(43) Pub. Date: Sep. 16, 2010

(54) DEVICE OPERATIONAL CONTROL SYSTEM, TOPOLOGY, AND METHODS VIA RF SIGNALS COMMUNICATED ON EXISTING RF INFRASTRUCTURE

(76) Inventor: Alexander Pummer, Pleasanton, CA (US)

Correspondence Address: MERLE W. RICHMAN, III, P.O. BOX 3333, LA JOLLA, CA, 92038, US

(21) Appl. No.: 12/401,614

(22) Filed: Mar. 10, 2009

(51) Int. Cl. H04B 7/00

(52) U.S. Cl. 455/70

(57) ABSTRACT

Embodiments of a system, topology, and method for controlling the operation of several devices based on various parameters via RF signals communicated on existing RF infrastructure are described generally herein. Other embodiments may be described and claimed.

### TECHNICAL FIELD

Various embodiments described herein relate to controlling operation of various devices based on various parameters.

### BACKGROUND INFORMATION

It may be desirable to control the operation of one or more devices based on various parameters. The present invention provides a system, topology, and method for controlling the operation of one or more devices based on various parameters.

### BRIEF DESCRIPTION OF THE DRAWINGS

FIG. 1 is a block diagram of an RF based device control architecture according to various embodiments.

FIG. 2A is a block diagram of an RF based controlled device according to various embodiments.

FIG. 2B is a block diagram of an RF based controlled device according to various embodiments.

FIG. 3 is a block diagram of a controlled device according to various embodiments.

FIG. 4 is a block diagram of an RF based interface for a controlled device according to various embodiments.

FIG. 5 is a block diagram of an RF device control signal generation system according to various embodiments.

FIG. 6A is a block diagram of a combined RF audio signal and RF control signal generation system according to various embodiments.

FIG. 6B is a block diagram of another combined RF audio signal and RF control signal generation system according to various embodiments.

FIG. 7 is a flow diagram illustrating several methods according to various embodiments.

FIG. 8A is a block diagram of an article according to various embodiments.

FIG. 8B is a block diagram of an article according to various embodiments.

### DETAILED DESCRIPTION

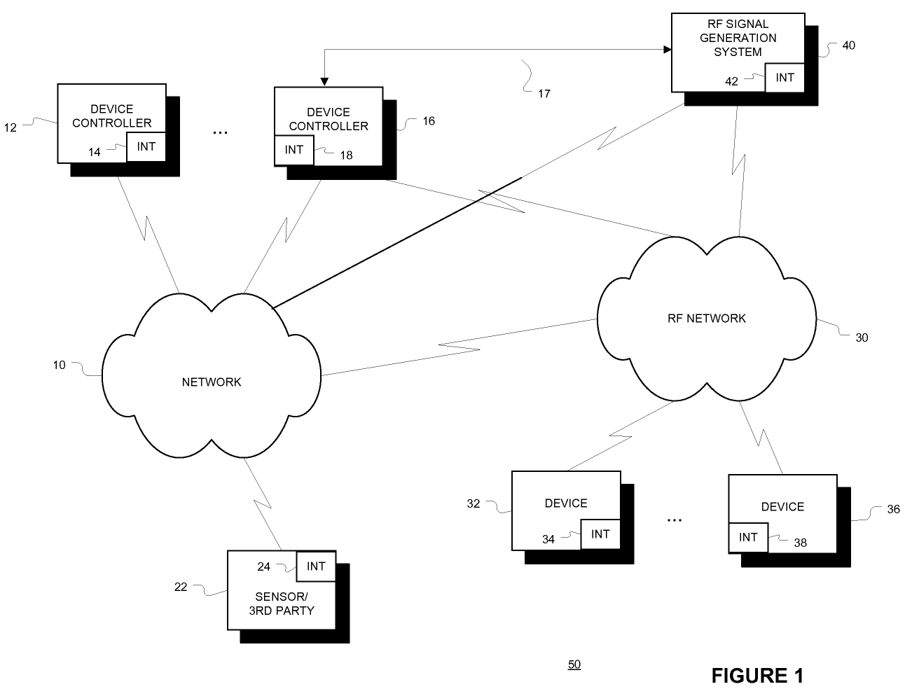

FIG. 1 is a block diagram of an RF based device control architecture 50 according to various embodiments. The architecture 50 includes a plurality of RF controlled devices 32, 36, an RF signal generation system 40, an RF network 30, a plurality of device controller systems 12, 16, a network 10, and a sensor or 3rd party data or parameter generation system 22. In brief a device controller 12 may generate an RF based control signal and insert the RF based control signal on an existing RF network 30 or provide an RF based control signal 17 to an existing RF signal generation system 40. The RF signal generation system 40 may then via an interface or RF transmitter 42 may insert the RF based control signal 17 (along with a standard RF signal) on the RF network 30.

In an embodiment the network 10 is an internet protocol (IP) based network including a network of networks or Internet. A device controller 12 via an interface 14 may forward device control information to be inserted on an existing radio frequency (RF) infrastructure signal via the RF signal generation system 40 on the RF network 30 via the network 10. The RF signal generation system 40 may receive the device control data from the network 10 via the interface 42 and may then generate or incorporate the device control data along with a standard RF signal. The RF signal generation system may then transmit the resultant signal on the RF network 30.

An RF controlled device 32 via an interface 34 may receive a standard RF signal on the network 30. The RF controlled device 32 interface 34 may extract device control data from the RF signal and control the device accordingly when the data is directed to the device. A sensor or 3rd party device 22 may compile data or parameters relevant to the control of one or more devices 32 and 34 and provide the compiled data or parameters to a device controller 12 via an interface 24. The data or parameters may include environmental data such as temperature, sun light intensity, precipitation data and human based data such as pedestrian or vehicular present or historical data for region(s) related to one or more devices 32, 36 to be controlled. The device 22 may also provide emergency directives requiring the immediate activation of one or more devices 32, 36 for a predetermined time interval. The sensor and 3rd party data and parameter device may forward the data, parameters, and directives to one or more device controllers 12, 16 via the network 10.

A device controller 12, 16 may receive data, parameters, and directives from various sources including the sensor and 3rd party device 22 and the RF signal generation system 40. The device controller 12, 16 may determine if one or more RF based controlled devices 32, 36 need operational modification based on the received data, parameters, and directives. The device controller 12, 16 may determine that one or more particular devices 32, 36, a preset group of devices 32, 36, or all devices need operational modification or verification based on the received signals. A device controller 12, 16 may then generate a control signal including data that may identify the one or more particular devices 32, 36, a preset group of devices 32, 36, or all devices and their desired state of operation. The device controller 12, 16 may need modulate the control signal for distribution on a existing RF system (the RF system including the RF signal generation system 40 and RF network 30).

The control signal may be limited analog or digital data that is modulated in an analog or digital format as an overlay of the existing RF system signal(s). A device controller 12, 14 may limit its signal strength based on measurements of the existing RF system signal(s). The device controller 12, 16 may also provide the control signal or data to the RF signal generation system 40 where the system 40 may incorporate the control signal or data in a predetermined format onto an existing RF signal(s).

A RF controlled device 32 interface 34 may monitor the RF network 30 signal(s) for the predetermined format of a control signal and control the operation of the device 32 based on detected control signals. In particular an interface 34 may determine whether the control signal is assigned to at least the device 32 (where the device 32 may be listed in the control signal or be a member of a group identified in the control signal). The interface 34 may then modify or verify operation of the device 32 based on the control signal.

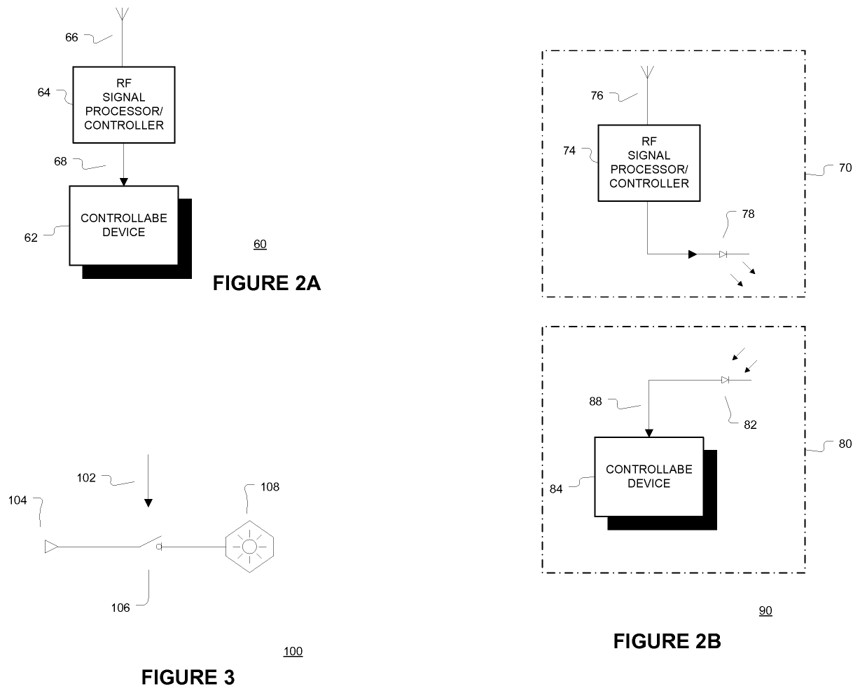

FIG. 2A is a block diagram of an RF based controlled device 60 that may be employed as an RF controlled device 32, 36. The RF based controlled device 60 includes a controllable device 62, RF signal processor and control signal generator module 64 and RF antenna 66. The RF signal processor and control signal generator module 64 may monitor the RF network 30 signal(s) via the antenna 66. The module 64 may search for the predetermined format of a device control signal. Upon detection of the such a signal the module 64 may determine whether the control signal is assigned to at least the controllable device 62 where the controllable device 62 may be listed in the control signal or be a member of a group identified in the detected control signal. The signal processor and control signal generator module 64 may generate a device operation signal 68 to control one or more operations of the device 62. The operations may include the intensity or volume of operation of the device 62.

FIG. 2B is a block diagram of an RF based controlled device 90 that may be employed as an RF controlled device 32, 36. The RF based controlled device 90 includes a photonically controlled device 80, an RF signal processor and photonic control signal generator with RF antenna 70. The RF signal processor and photonic control signal generator with RF antenna 70 includes an RF signal processor and signal control generator 74 coupled to an RF antenna 76 and a light or photon emitting diode 78. The light or photon controlled device 80 includes a light or photon detecting diode 82 coupled to a controllable device 84. The light detecting diode 82 may generate a control signal 88 that modulates the operation of the controllable device 84. In an embodiment an existing light controlled device 80 may be coupled to an RF signal based light control signal system 70 so the existing light controlled device 80 may be controlled remotely by an RF network 30.

The RF signal processor and control signal generator module 74 may monitor an RF network 30 signal(s) via the antenna 76. The module 74 may search for the predetermined format of a device control signal. Upon detection of the such a signal the module 74 may determine whether the control signal is assigned to at least the controllable device 84 where the controllable device 84 may be listed in the control signal or be a member of a group identified in the detected control signal. The signal processor and control signal generator module 74 may generate a device operation signal via the light emitting diode 78 to control one or more operations of the device 8, whose operation is controlled by the light detecting diode 82. The operations may include the intensity or volume of operation of the device 82 and the light intensity generated by the light emitting diode 78 may vary accordingly.

FIG. 3 is a block diagram of a power controlled device 100 according to various embodiments. The device 100 includes a power supply 104, signal 102 controlled switch 106, and device 108. In an embodiment the device to be controlled is a light including a street light, traffic signal, or other controllable light. The switch 106 may be variable controllable so the light may be dimmable or the switch 106 may only have an on or off operation as a function of the signal 102. The device 108 may include other controllable devices such as storm sewer bypass systems, watering systems, sirens, and other light based systems.

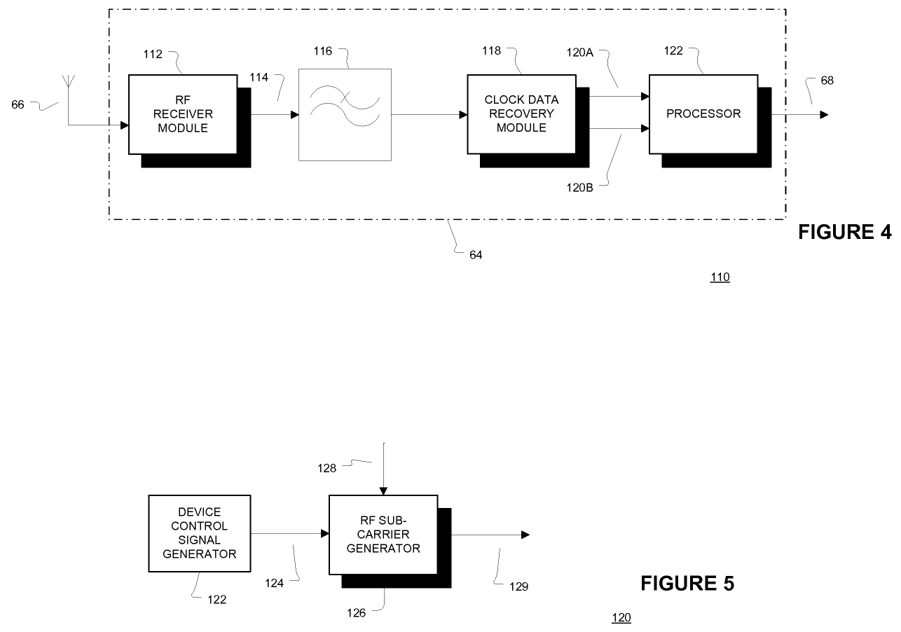

FIG. 4 is a block diagram of an RF signal processor and control signal generator module and antenna system 110 for a controlled device according to various embodiments. The system 110 includes an RF signal processor and control signal generator module 64 coupled to an RF antenna 66. The RF signal processor and control signal generator module 64 includes an RF receiver module 112, low pass filter (LPF) 116, clock and data recovery module 118 and signal processor 122. The RF receiver module receives an RF signal from the antenna 66 and demodulates the signal and frequency shifts the demodulated signal to a baseband signal 114. The demodulator may vary as a function of the signal modulation. In an embodiment the RF signal include amplitude modulation (AM) or frequency modulation (FM). The baseband signal 114 may be low pass filtered via the LPF 116.

The clock and data recovery module 118 may detect the presence of any device control signals that may exist in the baseband, low pass filtered signal. The clock and data recovery module 118 may generate a data signal 120A and related clock signal 120B for any detected device control signal. A signal processor 122 upon of a clock signal 120B may process the detected device control signal 120A. The signal processor may be programmed with an a group identifier (ID) or unique device ID for the one or more devices controlled by the processor 122. When the detected control signal is directed a related device 32, 36 the signal processor 122 may generate a control signal 68 that controls the operation of one or more related devices 32, 36. In an embodiment the RF receiver module 112, the low pass filter (LPF) 116, the clock and data recovery module 118 and the signal processor 122 may be incorporated in a single digital signal processor (DSP) or an application specific integrated circuit (ASIC).

FIG. 5 is a block diagram of an RF device control signal generation system 120 according to various embodiments. The RF device control signal generation system 120 includes a device control signal generator 122 and an RF sub-carrier generator 126. The device control signal generator 122 generates a control signal 124 to be modulated on an existing RF infrastructure to control one or more controllable devices 32, 36. The device control signal generator 122 may receive data and parameters from several sources and determine if any controllable devices need to be controlled. The signal generator 122 may then create one or more data signals to control one or more devices individually, as a group, or en mass.

The RF modulator 126 may be an RF sub-carrier generator that receives a control data signal 124 and an RF audio reference signal 128. The RF sub-carrier generator 126 may create a modulated signal 129 to be added to the an RF audio signal that is modulated and transmitted on a existing RF network 30. The RF sub-carrier generator 126 may modulate the signal level of the control signal 129 based on the audio reference signal 128 to limit or prevent oversaturation of the audio signal by the modulated signal 129.

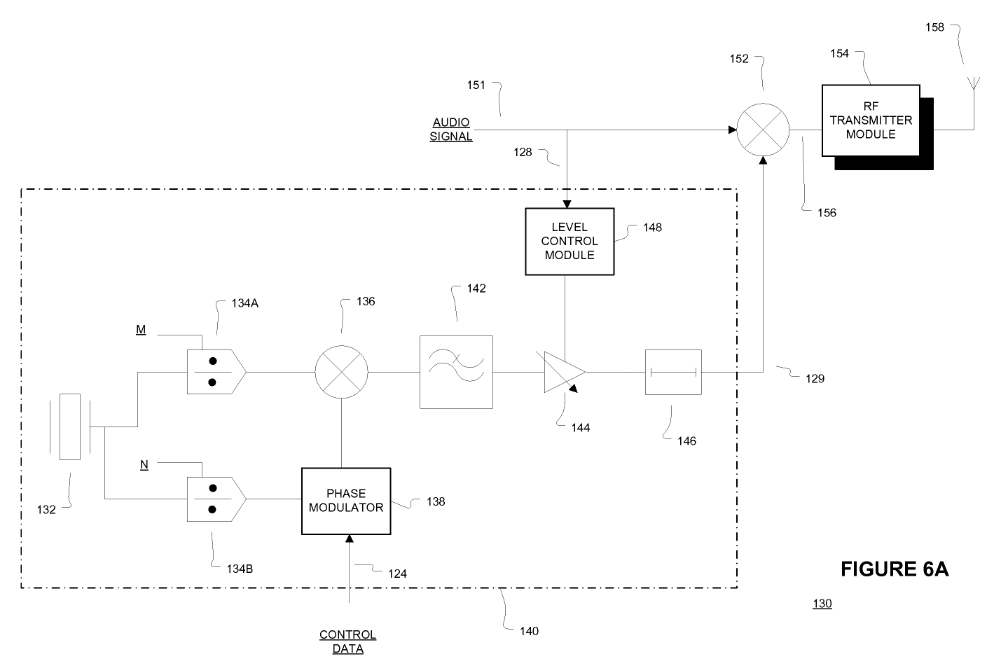

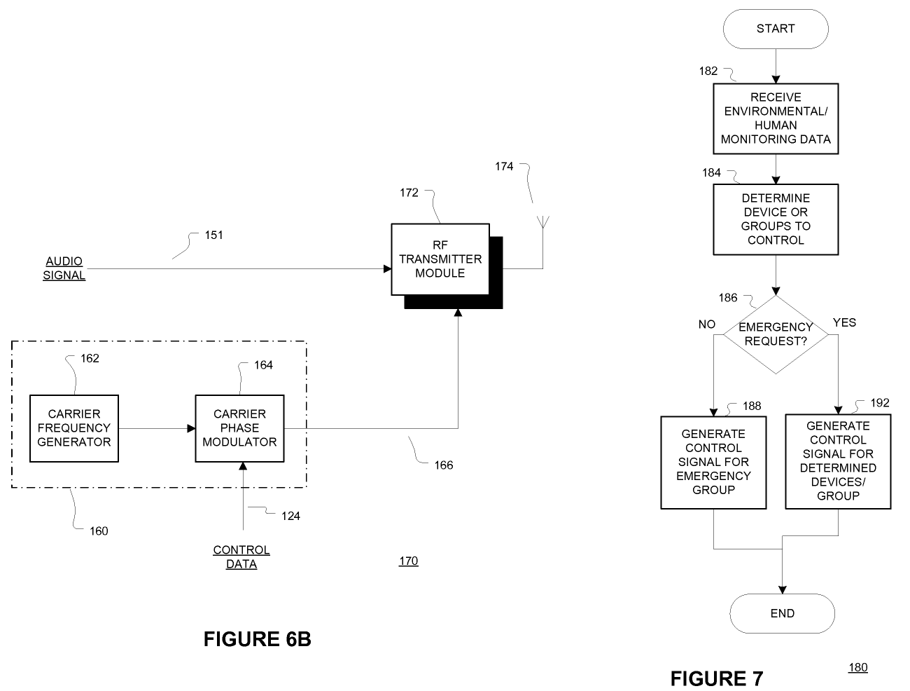

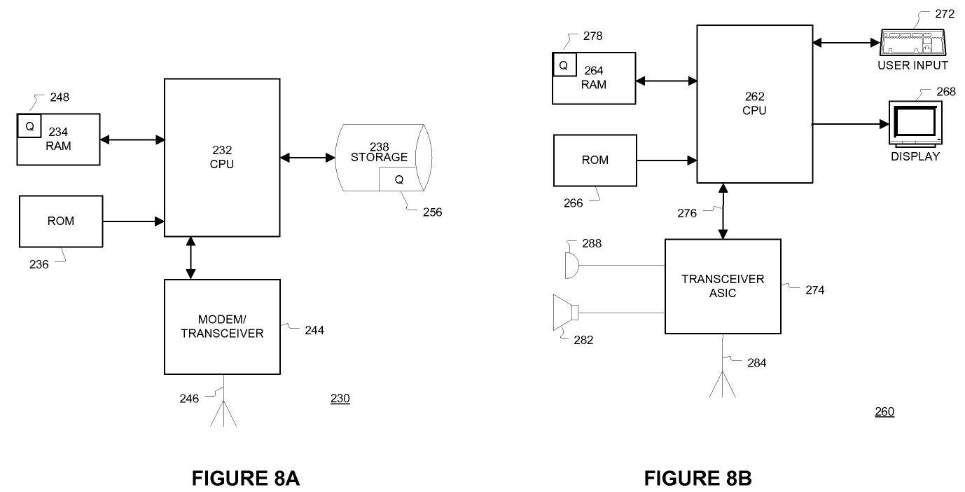

FIG. 6A is a block diagram of a combined RF audio signal and RF control signal generation system 130 according to various embodiments. The system 130 includes an RF sub-carrier control signal generator 140, an adder 152, an RF transmitter module 154, and an antenna 158. An audio signal to be transmitted on an existing RF network 30 is provided to the adder 152. A control data signal 124 to be modulated with the audio signal 151 is provided the RF sub-carrier control signal generator 140. The control signal generator 140 may include a reference oscillator 132, a M-divider 134A, an N-divider 134B, a linear adder 136, a phase modulator 138, a LPF 142, a variable gain amplifier 144, a delay circuit 146, and a level control module 148.

The reference oscillator 132 generates a signal having a predetermined frequency where the signal is reduced by M in the M-divider 134A and by N in the N-divider 134B. The control data 124 to be transmitted with on an existing RF network 30 as an overlay to an audio or other signal transmitted on the network 30 is used to phase modulate the N-divided signal in the phase modulator 138. The resultant N-divided, control signal phase modulated signal is linear summed with the M-divided signal in the linear summer 136. The resultant linear sum is low pass filtered by the LPR 142. The existing signal to be communicated on the RF network 151 is provided a reference signal 128 to a level control module 148. The level control module modulates the gain of a variable amplifier as a function of the reference signal. The low pass signal is amplified by the variable amplifier 144 and then time delayed by the delay 146. The resultant sub-carrier signal 129 includes a control signal phase modulated component. The sub-carrier signal 129 is added to the normally transmitted signal 151 to generate the baseband signal 156 to be transmitted on an existing RF system 40.

In an embodiment the RF system 40 is an AM radio station signal and the device control signal is randomly added to the AM radio station signal in the form of the phase modulated carrier-signal 129 when the system 50 communicates device control data to one or more devices 32, 36 in the system 50. The devices 32, 36 monitor the AM radio station signal and decode detected phase modulated sub-carrier signals to generate the transmitted control data. The sub-carrier signals, when transmitted have a lower signal strength than the AM radio station normal signal and may not interfere with normal AM receivers and their signal generation.

In an embodiment the oscillator 132, the M-divider 134A, the N-divider 134B, the linear adder 136, the phase modulator 138, the LPF 142, the variable gain amplifier 144, the delay circuit 146, and the level control module 148 may be incorporated into a single digital signal processor (DSP) or an application specific integrated circuit (ASIC). FIG. 6B is a block diagram of another combined RF audio signal and RF control signal generation system 170 according to various embodiments. The system 170 includes an RF carrier control signal generator 160, an RF transmitter module 172, and an antenna 174.

A signal to be transmitted on an existing RF network 30 is provided to the RF transmitter module 172. The RF carrier based control signal generator 140 may include an RF carrier frequency generator 162 coupled to a carrier signal phase modulator 164. The carrier frequency generator 162 generated a reference RF carrier signal. The carrier signal phase modulator 164 modulates the reference RF carrier signal based on received control data 124 (if any). The resultant phase modulated reference RF carrier signal 166 is added with the RF modulated signal 151 in the RF transmitter module 172 and communicated on the network 30 via the RF antenna 174.

FIG. 7 is a flow diagram illustrating several methods 170 according to various embodiments. A device controller 12, 16 or device control signal generator 122 may employ the method 180 illustrated by the FIG. 7 flow diagram. The method 180 may receive environmental or human related data or parameters (activity 182). The environmental or human related data may include temperature, sun light intensity, precipitation data and human based data such as pedestrian or vehicular present or historical data for region(s) related to one or more devices 32, 36 to be controlled. Based on the data, one or more devices, a group of devices, or all devices may require operations of these devices to be modified (activity 184). Based on the data and determined devices, groups, control signals for the devices or groups may be generated (activity 192). When an emergency or priority request is received (activity 186), control signals for the devices related to the emergency or priority request may be generated (activity 188). The resultant control signals may be folded into or onto an existing RF signal to be received, decoded, and processed by one or more RF based controllable devices 32, 36.

FIG. 6 illustrates a block diagram of a device 230 that may be employed as an interface 34, 38 for a controllable device 32, 36 and an interface 42 for the RF signal generation system 40 in various embodiments. The device 230 may include a central processing unit (CPU) 232, a random access memory (RAM) 234, a read only memory (ROM) 236, a storage unit 238, a modem/transceiver 244, and an antenna 246. The RAM 234 may include a queue or table 248 where the queue 248 may be used to store the environmental data, human data, device status information, device groupings, and control data history. The storage 238 may also include a queue or database 256 where the queue 256 may be used to store the environmental data, human data, device status information, device groupings, and control data history. The storage 238 may be local or coupled to the device 230 via one or more networks 10.

The modem/transceiver 244 may couple, in a well-known manner, the device 230 to the IP network 10, RF signal generation system 40, and the RF network 30 to enable communication with the devices 12, 16, 22, 32, 36, 40. In an embodiment, the modem/transceiver 244 may be a wireless or wired modem or other communication device that may enable communication with the devices 12, 16, 22, 32, 36, 40. The CPU 232 may direct communication between the modem 244 and a device 12, 16, 22, 32, 36, 40. The ROM 236 may store program instructions to be executed by the CPU 232. The RAM 234 may be used to store temporary program information, queues, databases, and overhead information. The storage device 238 may comprise any convenient form of data storage and may be used to store temporary program information, queues, databases, and overhead information.

A device 260 is shown in FIG. 7 that may be used in various embodiments as a an RF signal generation system 40, device controller 12, 16 or sensor/3rd party device 22. The device 260 may include a central processing unit (CPU) 262, a random access memory (RAM) 264, a read only memory (ROM”) 266, a display 268, a user input device 272, a transceiver application specific integrated circuit (ASIC) 274, a microphone 288, a speaker 282, and an antenna 284. The RAM 264 may include a queue 278 where the queue 278 may store store the environmental data, human data, device status information, device groupings, and control data history.

The ROM 266 is coupled to the CPU 262 and may store the program instructions to be executed by the CPU 262. The RAM 264 is coupled to the CPU 262 and may store temporary program data, overhead information, and the queues 278. The user input device 272 may comprise an input device such as a keypad, touch pad screen, track ball or other similar input device that allows the user to navigate through menus in order to operate the device 260. The display 268 may be an output device such as a CRT, LCD or other similar screen display that enables the user to read, view, or hear received messages, media, or pages from other devices 12, 14, 32, 36, 22, 40.

The microphone 288 and speaker 282 may be incorporated into the device 260. The microphone 288 and speaker 282 may also be separated from the device 260. Received data may be transmitted to the CPU 262 via a serial bus 276 where the data may include store the environmental data, human data, device status information, device groupings, and control data history to be transmitted, or protocol information. The transceiver ASIC 274 may include an instruction set necessary to communicate store the environmental data, human data, device status information, device groupings, and control data history in architecture 50 (for the IP network 10 or the RF network 30). The ASIC 274 may be coupled to the antenna 284 to communicate wireless store the environmental data, human data, device status information, device groupings, control data history, messages, media, or pages within the architecture 50. When a message is received by the transceiver ASIC 274, its corresponding data may be transferred to the CPU 262 via the serial bus 276. The data can include store the environmental data, human data, device status information, device groupings, control data history, wireless protocol, overhead information, media, and pages to be processed by the device 260 in accordance with the methods described herein.

Any of the components previously described can be implemented in a number of ways, including embodiments in software. Any of the components previously described can be implemented in a number of ways, including embodiments in software. Thus, the CPU 232, modem/transceiver 244, antenna 246, storage 238, RAM 234, ROM 236, queue 248, queue 256, CPU 262, transceiver ASIC 274, antenna 284, microphone 288, speaker 282, ROM 266, RAM 264, queue 278, user input 272, display 268 may all be characterized as “modules” herein.

The modules may include hardware circuitry, single or multi-processor circuits, memory circuits, software program modules and objects, firmware, and combinations thereof, as desired by the architect of the architecture 10 and as appropriate for particular implementations of various embodiments.

The apparatus and systems of various embodiments may be useful in applications other than a sales architecture configuration. They are not intended to serve as a complete description of all the elements and features of apparatus and systems that might make use of the structures described herein.

Applications that may include the novel apparatus and systems of various embodiments include electronic circuitry used in high-speed computers, communication and signal processing circuitry, modems, single or multi-processor modules, single or multiple embedded processors, data switches, and application-specific modules, including multilayer, multi-chip modules. Such apparatus and systems may further be included as sub-components within a variety of electronic systems, such as televisions, cellular telephones, personal computers (e.g., laptop computers, desktop computers, handheld computers, tablet computers, etc.), workstations, radios, video players, audio players (e.g., mp3 players), vehicles, medical devices (e.g., heart monitor, blood pressure monitor, etc.) and others. Some embodiments may include a number of methods.

It may be possible to execute the activities described herein in an order other than the order described. Various activities described with respect to the methods identified herein can be executed in repetitive, serial, or parallel fashion.

A software program may be launched from a computer-readable medium in a computer-based system to execute functions defined in the software program. Various programming languages may be employed to create software programs designed to implement and perform the methods disclosed herein. The programs may be structured in an object-orientated format using an object-oriented language such as Java or C++. Alternatively, the programs may be structured in a procedure-orientated format using a procedural language, such as assembly or C. The software components may communicate using a number of mechanisms well known to those skilled in the art, such as application program interfaces or inter-process communication techniques, including remote procedure calls. The teachings of various embodiments are not limited to any particular programming language or environment.

The accompanying drawings that form a part hereof show, by way of illustration and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein individually or collectively by the term “invention” merely for convenience and without intending to voluntarily limit the scope of this application to any single invention or inventive concept, if more than one is in fact disclosed. Thus, although specific embodiments have been illustrated and described herein, any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In the foregoing Detailed Description, various features are grouped together in a single embodiment for the purpose of streamlining the disclosure. This method of disclosure is not to be interpreted to require more features than are expressly recited in each claim. Rather, inventive subject matter may be found in less than all features of a single disclosed embodiment. Thus the following claims are hereby incorporated into the Detailed Description, with each claim standing on its own as a separate embodiment.

What is claimed is:

1. A device control signal processing module, including:
a radio frequency (RF) receiver to receive a RF signal including a primary audio signal component having a first energy level and a control signal component having a second energy level, the first energy level greater than the second energy level;
a control signal decoder to decode control signals when present in the RF signal; and
a device control signal generator to generate a device control signal based on the decoded control signal, an operation of a device controllable by the device control signal.

2. The device control signal processing module of claim 1, wherein the controllable device includes a photon generation device.

3. The device control signal processing module of claim 1, wherein the RF signal is an amplitude modulated signal.

4. The device control signal processing module of claim 1, wherein the control signal component is a baseband signal.

5. The device control signal processing module of claim 1, wherein the control signal component is a phase modulated signal.

6. The device control signal processing module of claim 2, wherein the device control signal generator generates a light based device control signal.

7. A device control signal processing method, comprising:
receiving an RF signal including a primary audio signal component having a first energy level and a control signal component having a second energy level, the first energy level greater than the second energy level;
decoding control signals when present in the RF signal; and
generating a device control signal based on the decoded control signal, an operation of a device controllable by the device control signal.

8. The device control signal processing method of claim 7, wherein the controllable device includes a photon generation device.

9. The device control signal processing method of claim 7, wherein the RF signal is an amplitude modulated signal.

10. The device control signal processing method of claim 7, wherein the control signal component is a baseband signal.

11. The device control signal processing method of claim 7, wherein the control signal component is a phase modulated signal.

12. The device control signal processing method of claim 8, comprising generating a light based device control signal.

13. The device control signal processing method of claim 7, further comprising determining when the decoded control signal is directed to a controllable device.

14. A device control signal generation system, including:
a control signal generation module, including:
a control signal encoder to encode control signals for at least one controllable device;
a combiner to combine the encoded control signal with a primary audio signal component; and
a transmitter to transmit the combined primary audio component and encoded control signals on a radio frequency network; and
a device controller module, including:
a radio frequency (RF) receiver to receive a RF signal including a primary audio signal component;
a control signal decoder to decode control signals when present in the RF signal; and
a device control signal generator to generate a device control signal based on the decoded control signal, an operation of a device controllable by the device control signal.

15. The device control signal generation system of claim 14, wherein the primary audio signal component has a first energy level and the control signal component has a second energy level, the first energy level greater than the second energy level.

16. The device control signal generation system of claim 14, wherein the controllable device includes a photon generation device.

17. The device control signal generation system of claim 14, wherein the RF signal is an amplitude modulated signal.

18. The device control signal generation system of claim 14, wherein the control signal component is a baseband signal.

19. The device control signal generation system of claim 14, wherein the control signal component is a phase modulated signal.

20. The device control signal generation system of claim 16, wherein the device control signal generator generates a light based device control signal.

21. A device control signal generation method, including:
at a control signal generation module, performing the steps of:
encoding control signals for at least one controllable device;
combining the encoded control signal with a primary audio signal component; and
transmitting the combined primary audio component and encoded control signals on a radio frequency network; and
at a device controller module, performing the steps of:
receiving a RF signal including a primary audio signal component;
decoding control signals when present in the RF signal; and
generating a device control signal based on the decoded control signal, an operation of a device controllable by the device control signal.

22. The device control signal generation method of claim 21, wherein the primary audio signal component has a first energy level and the control signal component has a second energy level, the first energy level greater than the second energy level.

23. The device control signal generation method of claim 21, wherein the controllable device includes a photon generation device.

24. The device control signal generation method of claim 21, wherein the RF signal is an amplitude modulated signal.

25. The device control signal generation method of claim 21, wherein the control signal component is a baseband signal.

26. The device control signal generation method of claim 21, wherein the control signal component is a phase modulated signal.

27. The device control signal generation method of claim 23, wherein the device control signal generator generates a light based device control signal.
